(19) United States
(12) Patent Application Publication
(10) Pub. No.: US 2024/0322137 A1
(43) Pub. Date: Sep. 26, 2024

(54) ELECTRODE FOR NON-AQUEOUS ELECTROLYTE RECHARGEABLE BATTERY AND NON-AQUEOUS ELECTROLYTE RECHARGEABLE BATTERY

(71) Applicant: SAMSUNG SDI CO., LTD., Yongin-si (KR)

(72) Inventors: Yuta TASHIRO, Yokohama-shi (JP); Hidekazu YAMAMOTO, Yokohama-shi (JP)

(21) Appl. No.: 18/614,502

(22) Filed: Mar. 22, 2024

(30) Foreign Application Priority Data
Mar. 24, 2023 (JP) 2023-048509

(51) Int. Cl. H01M 4/36; H01M 4/02; H01M 4/583; H01M 4/60; H01M 10/0525

(52) U.S. Cl. CPC H01M 4/366; H01M 4/583; H01M 4/602; H01M 2004/027; H01M 10/0525

(57) ABSTRACT

An electrode for a non-aqueous electrolyte rechargeable battery includes a current collector, an electrode mixture layer, and a conductive base layer between the current collector and the electrode mixture layer, wherein the base layer includes a styrene-butadiene copolymer, a carbon material, and poly(meth)acrylic acid, an amount of the styrene-butadiene copolymer in the base layer is greater than or equal to about 50 wt % and less than or equal to about 90 wt % based on 100 wt % of the base layer, in the poly(meth)acrylic acid, carboxyl groups included in the poly(meth)acrylic acid are not neutralized, or a proportion of neutralized carboxyl groups among the carboxyl groups is less than or equal to about 75%, and a weight per unit area of the electrode mixture layer at one surface of the current collector is greater than or equal to about 10 mg/cm² and less than or equal to about 35 mg/cm².

### CROSS-REFERENCE TO RELATED APPLICATION

This application claims priority to and the benefit of Japanese Patent Application No. 2023-048509 filed in the Japan Patent Office on Mar. 24, 2023, the entire content of which is incorporated herein by reference.

### BACKGROUND

### 1. Field

One or more embodiments of the present disclosure relate to an electrode for a non-aqueous electrolyte rechargeable battery and a non-aqueous electrolyte rechargeable battery including the electrode.

### 2. Description of the Related Art

Non-aqueous electrolyte rechargeable batteries, including lithium ion rechargeable batteries, are widely utilized as power sources for smart phones, notebook computers, and/or the like. More recently, as these electronic devices have become smaller and lighter, there is an increasing need (or desire) for rechargeable batteries to have higher energy densities.

In addition, in recent years, the demand (or the desire) for rechargeable batteries to be utilized as a power source for electric vehicles, hybrid vehicles, and/or the like has been increasing, and there is a demand (or a desire) for rechargeable batteries having relatively high energy density to ensure the same performance as comparable gasoline engines.

One example of a method for increasing an energy density of a rechargeable lithium ion battery is to increase a weight per unit area of the electrode mixture layer.

Normally, in the production of an electrode mixture layer, it is common to obtain the electrode mixture layer by coating and drying an electrode mixture slurry onto a current collector foil. However, as the weight per unit area of the electrode mixture layer is increased, a binder is more likely to migrate to the surface of the current collector, and the electrode mixture layer may or is likely to fall off or peel off (e.g., away from) the current collector foil.

Accordingly, in the production of an electrode mixture layer with a large weight per unit area, a method of dry mixing and kneading an electrode mixture composition, forming (or providing) it into a sheet utilizing a calendar press, and/or the like, and then bonding it to a current collector may also be utilized. Here, as a comparable method of preventing or reducing the electrode mixture layer from falling off or peeling off from the current collector, it is being considered to provide a base layer (e.g., a conductive base layer) between the current collector and the electrode mixture layer. See also, Japanese Patent Publication No. 2020/196372 (Patent Document 1). The entire content of Patent Document 1 is incorporated herein by reference.

The above information disclosed in this Background section is only for enhancement of understanding of the background of the disclosure and therefore it may contain information that does not constitute prior art.

### SUMMARY

According to comparable rechargeable batteries, the base layer of a rechargeable battery does not include an electrode active material and does not contribute to increasing the energy density of the rechargeable battery. Therefore, in order to increase energy density (e.g., to realize relatively high energy density), it is required (or there is desire) to make a thickness of the base layer thinner.

In addition, in actual battery configuration of comparable batteries, the electrode is impregnated with an electrolyte solution and the electrode is utilized in a state in which the electrolyte solution is impregnated. After such batteries are impregnated with the electrolyte solution, the electrode mixture layer may be easier to peel from the current collector than in the state before being impregnated with the electrolyte solution. In contrast, in the above-mentioned comparable method, there does not appear to be a study regarding the falling off or peeling of the electrode mixture layer after impregnation with the electrolyte solution.

Aspects of one or more embodiments of the present disclosure have been made in view of the above-mentioned problems, and while making a thickness of the base layer as small as possible, an electrode for a non-aqueous electrolyte rechargeable battery has a base layer that can sufficiently prevent or reduce the electrode mixture layer from falling off or peeling off from the current collector even after impregnation with an electrolyte solution in which the electrode mixture layer tends to fall off or peel off.

Additional aspects will be set forth in part in the description which follows and, in part, will be apparent from the description, or may be learned by practice of the presented embodiments of the disclosure.

One or more embodiments of the present disclosure include an electrode for a non-aqueous electrolyte rechargeable battery, including a current collector, an electrode mixture layer, and a conductive base layer between the current collector and the electrode mixture layer, wherein the base layer includes (at least) a styrene-butadiene copolymer, a carbon material, and poly(meth)acrylic acid, a content (e.g., amount) of the styrene-butadiene copolymer in the base layer is greater than or equal to about 50 wt % and less than or equal to about 90 wt % based on 100 wt % of the base layer, in the poly(meth)acrylic acid, carboxyl groups included in the poly(meth)acrylic acid are not neutralized, or a proportion of neutralized carboxyl groups among the carboxyl groups is less than or equal to about 75% (and, e.g., is greater than 0%), and a weight per unit area of the electrode mixture layer at one surface of the current collector is greater than or equal to about 10 mg/cm² and less than or equal to about 35 mg/cm².

In one or more embodiments, the base layer may have a thickness of greater than or equal to about 0.5 micrometer (μm) and less than or equal to about 5 μm.

In one or more embodiments, the base layer may have a thickness of greater than or equal to about 0.5 μm and less than or equal to about 2 μm.

In one or more embodiments, the styrene-butadiene copolymer may have a glass transition temperature of greater than or equal to about −30° C. and less than or equal to about 30° C.

In one or more embodiments, the electrode mixture layer may include polytetrafluoroethylene in an amount greater than or equal to about 0.5 wt % and less than or equal to about 10 wt % based on 100 wt % of the electrode mixture layer.

In one or more embodiments, in the poly(meth)acrylic acid, the carboxyl group the proportion of the neutralized carboxyl groups in the poly(meth)acrylic acid may be less than or equal to about 50% (and, e.g., is greater than 0%).

In one or more embodiments, the carbon material may include at least one furnace black, channel black, thermal black, ketjen black, and/or acetylene black.

One or more embodiments are include a non-aqueous electrolyte rechargeable battery including a positive electrode, a negative electrode, a separator between the positive electrode and the negative electrode, and an electrolyte, wherein the positive electrode and/or the negative electrode is the electrode for a non-aqueous electrolyte rechargeable battery as described herein.

One or more embodiments include a non-aqueous electrolyte rechargeable battery including a positive electrode, a negative electrode, a separator between the positive electrode and the negative electrode, and an electrolyte (e.g., an electrolyte solution), wherein at least one of the positive electrode and/or the negative electrode is the electrode for a non-aqueous electrolyte rechargeable battery as described herein.

According to aspects of one or more embodiments the present disclosure, in the electrodes in which a weight per unit area of the electrode mixture layer at one surface of the current collector is (sufficiently) increased, even if the thickness of the base layer is (sufficiently) decreased to the range capable of achieving as relatively high energy density as desired or suitable, the electrode mixture layer may be suppressed or reduced from falling off or peeling off from the current collector after being impregnated with the electrolyte solution.

In the comparable art, the electrode mixture layer may become prone to peel off from the current collector after being impregnated with the electrolyte solution, which may be particularly problematic for a negative electrode. Accordingly, the negative electrode for a non-aqueous electrolyte rechargeable battery according to embodiments of the present disclosure, which is utilized to manufacture a non-aqueous electrolyte rechargeable battery, may be exhibit the effects of the present disclosure by preventing or reducing the detachment of the electrode mixture layer.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described, by referring to the drawings, to explain aspects of the present description. The embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

As used herein, the term “and/or” includes any and all combinations of one or more of the associated listed items. Unless otherwise apparent from the disclosure, expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c,” “at least one of a to c” indicates only a, only b, only c, both a and b, both a and c, both b and c, all of a, b, and c, or variations thereof.

As the present disclosure described hereinafter allows for various changes and numerous embodiments, embodiments will be illustrated in the drawings and described in more detail in the detailed description.

Hereinafter, embodiments will be described in more detail so that those of ordinary skill in the art can easily implement them. However, this disclosure may be embodied in many different forms and is not construed as limited to the example embodiments set forth herein.

The terminology used herein is for the purpose of describing particular embodiments only, and is not intended to limit the present disclosure. As used herein, the singular forms “a,” “an” and “the” are intended to include the plural forms as well, unless the context clearly indicates otherwise.

Unless otherwise defined, all terms (including chemical names and other technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the phrase “combination thereof” means a mixture, a laminate, a composite, a copolymer, an alloy, a blend, a reaction product, and the like of the constituents.

As used herein, the terms “use,” “using,” and “used” may be considered synonymous with the terms “utilize,” “utilizing,” and “utilized,” respectively.

It will be further understood that the terms “comprises,” “comprising,” “includes,” “including,” “have,” “has,” and “having,” when used in this specification, specify the presence of the stated features, integers, steps, operations, elements, and/or components, but do not preclude the presence or addition of one or more other features, integers, steps, operations, elements, components, and/or groups thereof.

The term “may” will be understood to refer to “one or more embodiments of the present disclosure,” some of which include the described element and some of which exclude that element and/or include an alternate element. Further, the use of “may” when describing embodiments of the present disclosure refers to “one or more embodiments of the present disclosure.” Similarly, alternative language such as “or” refers to “one or more embodiments of the present disclosure,” each including a corresponding listed item.

Spatially relative terms, such as “on,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the present disclosure, “consisting essentially of” means that any additional components will not materially affect the chemical, physical, optical or electrical properties of the semiconductor film. Further, in this specification, the phrase “on a plane,” or “plan view,” means viewing a target portion from the top, and the phrase “on a cross-section” means viewing a cross-section formed by vertically cutting a target portion from the side. In the present disclosure, “not include (or not including) a or any “component,” “exclude (or excluding) a or any “component,” “component-free,” and/or the like refers to that the “component” has not been added, selected or utilized as a component or compound in the composition, but the “component” in less than a suitable or utilizable amount may still be included due to other impurities and/or external factors.

It will be understood that when an element such as a layer, film, region, or substrate is referred to as being “on” another element, it can be directly on the other element or one or more intervening elements may also be present. In contrast, when an element is referred to as being “directly on” another element, there are no intervening elements present. In addition, it will also be understood that when an element is referred to as being “between” two elements, it can be the only element between the two elements, or one or more intervening elements may also be present.

In addition, “layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and/or the like.

“Metal” is interpreted as a concept including ordinary metals, transition metals and metalloids (semi-metals).

As used herein, poly(meth)acrylic acid refers to polyacrylic acid (PAA) and/or polymethacrylic acid (PMAA).

Hereinafter, a specific configuration of a non-aqueous electrolyte rechargeable battery according to one or more embodiments will be described.

### 1. Basic Configuration of Non-Aqueous Electrolyte Rechargeable Battery

The non-aqueous electrolyte rechargeable battery according to one or more embodiments is a rechargeable lithium ion battery including a positive electrode, a negative electrode, a separator, and a non-aqueous electrolyte interspersed therein.

The shape of the rechargeable lithium ion battery is not particularly limited, but may be, for example, a cylindrical shape, a prismatic shape, a laminated shape, or a button shape.

### 1-1. Positive Electrode

The positive electrode includes a positive electrode current collector and a positive electrode mixture layer on the positive electrode current collector.

The positive electrode current collector may be any material as long as it is a conductor, and is, for example, plate-shaped or thin, and may be desirably made of aluminum, stainless steel, nickel coated steel, and/or the like.

The positive electrode mixture layer may include at least a positive electrode active material, and may further include a conductive agent and a positive electrode binder.

The positive electrode active material may be, for example, a transition metal oxide or a solid solution oxide including lithium, and is not particularly limited as long as it can electrochemically intercalate and deintercalate lithium ions. Examples of the transition metal oxide including lithium may include Li_{1.0}Ni_{0.88}Co_{0.1}Al_{0.01}Mg_{0.01}O₂, and/or the like. In one or more embodiments, the transition metal oxide may include Li·Co composite oxides such as LiCoO₂ and Li·Ni·Co—Mn-based composite oxides such as LiNiₓCo_{y}Mn_{z}O₂, Li—Ni-based composite oxide such as LiNiO₂, or Li—Mn-based composite oxides such as LiMn₂O₄, and/or the like. Examples of the solid solution oxide may include LiₐMnₓCo_{y}Ni_{z}O₂ (1.150≤a≤1.430, 0.45≤x≤0.6, 0.10≤y≤0.15, 0.20≤z≤0.28), and/or LiMn_{1.5}Ni_{0.5}O₄. In one or more embodiments, a content (e.g., amount or content ratio) of the positive electrode active material is not particularly limited, as long as it is generally utilized and/or generally available or applicable to the positive electrode mixture layer of a non-aqueous electrolyte rechargeable battery. Moreover, these compounds may be utilized alone or may be utilized in a mixture of two or more compounds.

The conductive agent (e.g., conductor) is not particularly limited as long as it is for increasing the conductivity of the positive electrode. Specific examples of the conductive agent include conductive agents containing (including) one or more of (e.g., selected from among) carbon black, natural graphite, artificial graphite, fibrous carbon, and/or nanocarbon materials (carbon materials in a nano scale).

Examples of the carbon black may include furnace black, channel black, thermal black, ketjen black, and acetylene black.

Examples of the fibrous carbon may include carbon fibers and/or the like.

Examples of the nanocarbon material may include carbon nanotubes, carbon nanofibers, a single-layer graphene, and/or a multi-layer graphene.

The content (e.g., amount) of the conductive agent is not particularly limited, and may be any content (e.g., amount) generally utilized and/or generally available or applicable to the positive electrode mixture layer of a non-aqueous electrolyte rechargeable battery.

The positive electrode binder may be, for example, a fluorine-containing resin such as polytetrafluoroethylene (PTFE) and polyvinylidene fluoride, an ethylene-containing resin such as a styrene-butadiene rubber, and ethylene propylene-diene terpolymer, an acrylonitile-butadiene rubber, a fluororubber, polyvinyl acetate, polymethylmethacrylate, polyethylene, polyvinyl alcohol, carboxymethyl cellulose, a carboxymethylcellulose derivative (a salt of carboxymethylcellulose, and/or the like), nitrocellulose, and/or the like. The positive electrode binder is not particularly limited as long as it is capable of binding the positive electrode active material and the conductive agent to the positive electrode current collector. From the viewpoint of increasing a weight per unit area of the positive electrode mixture layer, it is desirable that the positive electrode mixture layer includes a fluorine-containing resin such as polytetrafluoroethylene (PTFE) or polyvinylidene fluoride as a binder, and a binder content (e.g., amount) in the positive electrode mixture layer is greater than or equal to about 0.5 parts by weight (that is, wt %) and less than or equal to about 10 parts by weight (that is, wt %). If the binder content (e.g., amount) is within this range, a mechanical strength of the positive electrode mixture layer is improved to a level that can ensure good or suitable processability, and the energy density of the positive electrode plate can be increased.

### 1-2. Negative Electrode

The negative electrode includes a negative electrode current collector and a negative electrode mixture layer on the negative electrode current collector.

The negative electrode current collector may be any suitable material as long as it is a conductor, and may be desirably plate-shaped or thin, and made of copper, stainless steel, nickel-plated steel, and/or the like.

The negative electrode mixture layer may include at least a negative electrode active material and may further include a conductive agent and a negative electrode binder.

The negative electrode active material is not particularly limited as long as it can electrochemically intercalate and deintercalate lithium ions, but, may be, for example, a graphite active material (artificial graphite, natural graphite, a mixture of artificial graphite and natural graphite, and/or natural graphite coated with artificial graphite), a Si-based active material, a Sn-based active material (e.g., a mixture of fine particles of silicon (Si) or tin (Sn) and/or a (e.g., any suitable) mixture of oxides thereof and a graphite active material, particulates of silicon or tin, and/or an alloy including silicon or tin as a base material), metallic lithium, a titanium oxide compound such as Li₄Ti₅O₁₂, lithium nitride, and/or the like. As the negative electrode active material, one of the above examples may be utilized, or two or more types (kinds) may be utilized in combination. In one or more embodiments, oxides of silicon may be represented by SiOₓ (0<x≤2).

The conductive agent is not particularly limited as long as the conductive agent is for increasing the conductivity of the negative electrode, and for example, the conductive agent may be the same conductive agent as described in the section of the positive electrode.

The negative electrode binder is not particularly limited as long as it is capable of binding the negative electrode active material and the conductive agent to the negative electrode current collector. The negative electrode binder may be, for example, polyvinylidene difluoride (PVDF), polytetrafluoroethylene (PTFE), polyacrylic acid (PAA), polymethacrylic acid (PMAA), a styrene-butadiene-based copolymer (SBR), and a metal salt of carboxymethyl cellulose (CMC), and/or the like. One type or kind of binder may be utilized alone, or two or more types (kinds) may be included.

### 1-3. Separator

The separator is not particularly limited, and any (suitable) separator may be utilized as long as it is utilized as a separator for a rechargeable lithium ion battery. The separator may be a porous film, nonwoven fabric, and/or the like that exhibits excellent or suitable high-rate discharge performance alone or in combination. The resin constituting the separator may be, for example, a polyolefin-based resin such as polyethylene, polypropylene, etc., a polyester resin such as polyethylene terephthalate, polybutylene terephthalate, etc., polyvinylidene difluoride, a vinylidene difluoride-hexafluoropropylene copolymer, a vinylidene difluoride-perfluorovinyl ether copolymer, a vinylidene difluoride-tetrafluoroethylene copolymer, a vinylidene difluoride-trifluoroethylene copolymer, a vinylidene difluoride-hexafluoroacetone copolymer, a vinylidene difluoride-ethylene copolymer, a vinylidene difluoride-propylene copolymer, a vinylidene difluoride-trifluoro propylene copolymer, a vinylidene difluoride-hexafluoroethylene copolymer, a vinylidene difluoride-ethylene-tetrafluoroethylene copolymer, and/or the like. In one or more embodiments, a porosity of the separator is not particularly limited, and it is possible to arbitrarily apply (or select) a porosity of the separator as generally available and/or generally utilized in a rechargeable lithium ion battery.

On the surface of the separator, there may be a heat resistant layer including inorganic particles to improve heat resistance, or a layer including an adhesive for fixing the battery element by adhering to the electrode. The aforementioned inorganic particles may include Al₂O₃, AlOOH, Mg(OH)₂, SiO₂, and/or the like. Examples of the adhesive may include a vinylidene fluoride-hexafluoropropylene copolymer, an acid-modified product of vinylidene fluoride polymers, and a styrene-(meth)acrylic acid ester copolymer.

### 1-4. Non-Aqueous Electrolyte

As the non-aqueous electrolyte solution, a non-aqueous electrolyte solution that is generally available and/or generally utilized for rechargeable lithium ion batteries may be utilized without particular limitation. The non-aqueous electrolyte solution may have a composition in which an electrolyte salt is included in a non-aqueous solvent, which is a solvent for the electrolyte solution. Examples of the non-aqueous solvent may include cyclic carbonate esters such as propylene carbonate, ethylene carbonate, butylene carbonate, chloroethylene carbonate, fluoroethylene carbonate, and vinylene carbonate, cyclic esters such as γ-butyrolactone and γ-valerolactone, chain carbonates such as dimethyl carbonate, diethyl carbonate, or ethyl methyl carbonate, chain esters such as methyl formate, methyl acetate, methyl butyrate, ethyl propionate, propyl propionate, ethers such as tetrahydrofuran or a derivative thereof, 1,3-dioxane, 1,4-dioxane, 1,2-dimethoxyethane, 1,4-dibutoxyethane, methyldiglyme, ethylene glycol monopropyl ether, or propylene glycol monopropyl ether, nitriles such as acetonitrile and benzonitrile, dioxolane or a derivative thereof, ethylene sulfide, sulfolane, sultone, or a derivative thereof, which may be utilized alone or in a mixture of two or more. In one or more embodiments, if two or more types (kinds) of non-aqueous solvents are mixed and utilized, a mixing ratio of each non-aqueous solvent may be a mixing ratio that may be utilized in a comparable or rechargeable lithium ion battery of the related art.

Examples of the electrolyte salt may include an inorganic ion salt including one of lithium (Li), sodium (Na) or potassium (K) such as LiClO₄, LiBF₄, LiAsF₆, LiPF₆, LiPF₆₋ₓ(CnF₂ₙ₊₁)ₓ (provided that 1<x<6 and n=1 or 2), LiSCN, LiBr, LiI, Li₂SO₄, Li₂B₁₀Cl₁₀, NaClO₄, NaI, NaSCN, NaBr, KClO₄, KSCN, or an organic ion salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, lithium stearyl sulfonate, lithium octyl sulfonate, lithium dodecylbenzene sulfonate, and/or the like, and it is also possible to utilize these ionic compounds alone or in a mixture of two or more types (kinds). In one or more embodiments, a concentration of the electrolyte salt may be the same as that of a non-aqueous electrolyte solution utilized in a comparable or rechargeable lithium ion battery of the related art, and the present disclosure is not particularly limited. In one or more embodiments, it is desirable to utilize a non-aqueous electrolyte solution including the above-described lithium compound (electrolyte salt) at a concentration of greater than or equal to about 0.8 mol/L and less than or equal to about 1.5 mol/L.

In one or more embodiments, one or more suitable additives may be added to the non-aqueous electrolyte solution. Examples of such additives may include negative electrode-acting additives, positive electrode-acting additives, ester additives, carbonate ester additives, sulfuric acid ester additives, phosphoric acid ester additives, boric acid ester additives, acid anhydride additives, and electrolyte additives. Any one of these may be added to the non-aqueous electrolyte solution, and multiple types (kinds) of additives may be added to the non-aqueous electrolyte solution.

### 2. Characteristic Configuration of Non-Aqueous Electrolyte Rechargeable Battery According to One or More Embodiments

Hereinafter, a characteristic configuration of the non-aqueous electrolyte rechargeable battery according to one or more embodiments will be described.

### 2-1. Base Layer

The aforementioned negative electrode further includes a base layer.

The base layer is provided between the negative electrode current collector and the negative electrode mixture layer, and prevents the negative electrode mixture layer from falling off or peeling off of the negative electrode current collector.

The base layer includes a carbon material, a binder (binder for the base layer), and a dispersant.

The carbon material is not particularly limited as long as it is utilized to increase the conductivity of the base layer. Examples of the carbon material may include those containing one or more of (e.g., selected from among) carbon black, natural graphite, artificial graphite, fibrous carbon, and/or nanocarbon materials.

Examples of the carbon black may include furnace black, channel black, thermal black, ketjen black, and acetylene black.

Examples of the fibrous carbon include carbon fiber and/or the like.

Examples of the nanocarbon material may include carbon nanotubes, carbon nanofibers, a single-layer graphene, and/or a multi-layer graphene.

Among carbon materials, it is desirable to utilize carbon black, which is easy to disperse. Among carbon blacks, it is more desirable to utilize acetylene black, which has relatively high conductivity.

A content (e.g., amount) of the carbon material in the base layer may be greater than or equal to about 1 wt % and less than or equal to about 35 wt %, and for example greater than or equal to about 5 wt % and less than or equal to about 30 wt %. If the content (e.g., amount) of the carbon material is greater than or equal to about 1 wt %, the conductivity of the base layer becomes good or suitable, and if the content (e.g., amount) of the carbon material is greater than or equal to about 5 wt %, the conductivity of the base layer may improve.

In one or more embodiments, lowering the content (e.g., amount) of the carbon material leaves room for increasing the content (e.g., amount) of the binder and dispersant for the aforementioned base layer, which leads to the development of good or suitable adhesiveness and improved dispersibility of the base layer. Accordingly, the content (e.g., amount) of the carbon material may be less than or equal to about 35 wt %, or less than or equal to about 30 wt %.

The binder for the base layer binds each component, such as a carbon material included in the base layer, to each other and also binds the base layer and the electrode current collector and/or the electrode mixture layer. For example, the binder for the base layer according to one or more embodiments includes a styrene-butadiene copolymer (also referred to as SBR), and may be made of a styrene-butadiene copolymer.

The styrene-butadiene copolymer is a copolymer mainly composed of structural units made by polymerizing styrene and butadiene. In the binding the base layer with the electrode current collector or the electrode mixture layer, as the binder for a base layer is softened, an adhesive force is exhibited. Herein, a temperature that the styrene-butadiene copolymer is softened is a glass transition temperature. The glass transition temperature of the styrene-butadiene copolymer is in general lower than that of a fluorine resin such as PVDF (e.g., a melting point: about 177° C.) and/or the like and thereby, may reduce a temperature of an adhesive process, which may be advantageous in terms of reducing a manufacturing coat.

The styrene-butadiene copolymer includes emulsion polymerization SBR and solution polymerization SBR. The emulsion polymerization SBR is obtained in a state of aqueous dispersion (also, called to be emulsion or latex). When SBR is synthesized through the emulsion polymerization, an emulsifier may be sometimes prescribed. In order to disperse and stabilize SBR particulates, a small portion of them may be modified with monomers such as unsaturated carboxylic acid, an unsaturated nitrile compound, and/or the like. In order to disperse and stabilize the SBR particulates in water, a surfactant may be added thereto. The SBR particulates may be complexed with different types (kinds) of polymers. The complexed SBR particulates may have a structure such as a core-shell structure, a sea-island structure, and/or the like.

In one or more embodiments, it is desirable to utilize an aqueous dispersion of the emulsion polymerized styrene-butadiene copolymer as a binder for a base layer. The styrene-butadiene copolymer has relatively low viscosity in the aqueous dispersion state. The binder for a base layer with relatively low viscosity may contribute to deteriorating viscosity of a slurry for a base layer. The slurry for a base layer with relatively low viscosity may be advantageous in terms of coating a thin film. The emulsion polymerized styrene-butadiene copolymer has, for example, a relatively large molecular weight of greater than or equal to about 10,000 and less than or equal to about 3,000,000. The binder for a base layer with a large molecular weight may contribute to increasing strength of the binder for a base layer itself and in turn, increasing strength of the base layer. The base layer with relatively high strength may contribute to lowering a defect rate of a coating film.

As described above, the aqueous dispersion of the styrene-butadiene copolymer may include additives such as an emulsifier and a surfactant. In one or more embodiments, a small portion thereof may be modified with monomers such as unsaturated carboxylic acid, an unsaturated nitrile compound, and/or the like. The additives or the modification may affect pH of the aqueous dispersion of the styrene-butadiene copolymer.

When the binder for a base layer is mixed with other materials except for the binder for a base layer to prepare slurry for a base layer, the aqueous dispersion of the binder for a base layer should have a desirable pH range. For example, if pH of the other materials except for the binder for a base layer is less than about 7, if (e.g., when) the binder for a base layer is not strongly alkaline but alkaline close to neutral, or in one or more embodiments, neutral or acidic, the formation of aggregates due to acid-base interaction in the slurry for a base layer may be suppressed or reduced. If the formation of aggregates is suppressed or reduced in the slurry for a base layer, a deterioration of a coating property of the base layer formed by coating the slurry for a base layer may be suppressed or reduced.

In one or more embodiments, poly(meth)acrylic acid is utilized as a dispersant for a base layer, which will be described in more detail later. An aqueous solution of the poly(meth)acrylic acid has pH of less than about 7. In order to suppress or reduce the formation of aggregates through the aforementioned mechanism, a binder for a base layer with pH of less than or equal to 8 may be utilized.

The styrene-butadiene copolymer may have a glass transition temperature of less than or equal to about 30° C. and more than or equal to about −30° C. The styrene-butadiene copolymer is softened at a higher temperature than the glass transition temperature. The styrene-butadiene copolymer, if (e.g., when) sufficiently softened, may express satisfactory adhesiveness in a process of adhering the negative electrode mixture layer to the base layer. If the glass transition temperature is less than or equal to about 30° C., if (e.g., when) the negative electrode mixture layer is adhered to the base layer, satisfactory adhesiveness may be obtained without setting a heat roll press at an excessively (or substantially) high temperatures, for example, at greater than about 120° C. The glass transition temperature of the styrene-butadiene copolymer may be greater than or equal to about −20° C. and less than or equal to about 20° C. or greater than or equal to about −15° C. and less than or equal to about 15° C.

The styrene-butadiene copolymer, which is in a dried state, if (e.g., when) impregnated with an electrolyte solution, may be to absorb the electrolyte solution and swell. However, an excessively (or substantially) high swelling degree may contribute to deteriorating adhesion strength between electrode mixture layer and base layer. Accordingly, the styrene-butadiene copolymer may have a swelling degree of less than about 278 wt %. The swelling degree may be less than or equal to about 200 wt %, or less than or equal to about 150 wt %.

Examples of the styrene-butadiene copolymer satisfying the aforementioned properties may include, for example, TRD2001, TRD102A, and TRD104A, which are manufactured by ENEOS INC., BM-451B manufactured by Zeon Corp., and/or the like.

In order to sufficiently prevent or substantially prevent the electrode mixture layer from falling off or peeling off the base layer after being impregnated with the electrolyte solution, a content (e.g., amount) of the binder in the base layer may be greater than or equal to about 50 wt %. In one or more embodiments, in order to sufficiently ensure the conductivity of the base layer, the content (e.g., amount) of the binder in the base layer may be less than or equal to about 90 wt %. The content (e.g., amount) of the binder in the base layer may be greater than about 55 wt % and less than or equal to about 85 wt %, greater than or equal to about 60 wt % and less than or equal to about 85 wt %, or, for example, greater than or equal to about 60 wt % and less than or equal to about 80 wt %.

The dispersant is utilized to uniformly (substantially uniformly) disperse the carbon material and the binder for the base layer, and in one or more embodiments, the dispersant may be poly(meth)acrylic acid.

The poly(meth)acrylic acid has a plurality of carboxyl groups in the molecule, and these carboxyl groups may be neutralized by alkali metal ions such as sodium ions.

In the poly(meth)acrylic acid utilized in one or more embodiments, the carboxyl groups may be as unneutralized if possible. For example, a proportion of neutralized carboxyl groups (neutralized carboxyl groups) among the carboxyl groups included in poly(meth)acrylic acid may be less than or equal to about 20%, less than or equal to about 10%, or, for example, 0% (i.e., unneutralized). That is, a proportion of neutralized carboxyl groups among the carboxyl groups included in the poly(meth)acrylic acid is greater than about 0% and less than or equal to about 75%. For example, a proportion of neutralized carboxyl groups among the carboxyl groups included in the poly(meth)acrylic acid is greater than about 0% and less than or equal to about 50%.

A content (e.g., amount) of the dispersant in the base layer may be greater than or equal to about 1 wt % and less than or equal to about 30 wt %, and for example greater than or equal to about 2 wt % and less than or equal to about 25 wt %, or greater than or equal to about 3 wt % and less than or equal to about 20 wt %. If the content (e.g., amount) of the dispersant is greater than or equal to about 1 wt %, the above-described carbon material and the binder for the base layer can be uniformly (substantially uniformly) dispersed, and if (e.g., when) the content (e.g., amount) of the dispersant is greater than or equal to about 2 wt %, the binder can be dispersed more uniformly (e.g., substantially more uniformly). In contrast, lowering the content (e.g., amount) of the dispersant leaves room for increasing the content (e.g., amount) of the aforementioned binder for the base layer and conductive agent, which leads to improved battery performance by developing good or suitable adhesiveness of the base layer and lowering the resistance. Accordingly, the content (e.g., amount) of the dispersant may be less than or equal to about 25 wt %, less than or equal to about 30 wt %, or for example less than or equal to about 25 wt %.

### 3. Manufacturing Method of Non-Aqueous Electrolyte Rechargeable Battery According to One or More Embodiments

Hereinafter, the manufacturing method of the rechargeable lithium ion battery according to the one or more embodiments is described.

### 3-1. Manufacturing Method of Positive Electrode

The positive electrode according to one or more embodiments is manufactured as follows.

For example, a positive electrode active material, a conductive agent, and a positive electrode binder are mixed in a desired or suitable ratio and kneaded to manufacture a positive electrode mixture lump, and the positive electrode mixture lump is compressed to manufacture a positive electrode mixture sheet. A positive electrode is manufactured by a dry method in which the positive electrode mixture sheet is laminated on a positive electrode current collector utilizing a hot roll press and/or the like. In one or more embodiments, the manufacturing equipment utilized in the process of laminating the positive electrode mixture sheet to the positive electrode current collector by a dry method is not particularly limited. As manufacturing equipment utilized in the process of laminating the positive electrode mixture sheet to the positive electrode current collector, roll press equipment, hot roll press equipment, dry laminator, calendar processing equipment, heat press equipment, and/or the like may be considered. In the above laminating process, for example, if (e.g., when) utilizing a hot roll press equipment, the press roll temperature of the hot roll press equipment can be appropriately or suitably changed depending on the material utilized in the positive electrode mixture layer and/or the like, but may be greater than or equal to about 20° C. and less than or equal to about 150° C., greater than or equal to about 30° C. and less than or equal to about 120° C., or, for example, greater than or equal to about 40° C. and less than or equal to about 80° C. Moreover, the rotation speed of the press roll may be greater than or equal to about 0.1 m per minute and less than or equal to about 10 m per minute, greater than or equal to about 0.1 m per minute and less than or equal to about 5 m per minute, or, for example, greater than or equal to about 0.1 m per minute and less than or equal to about 1.0 m per minute. Various parameters, including the temperature of the press roll and the rotation speed of the press roll, may have different desirable ranges depending on the hot roll press equipment utilized, and the parameters may be adjusted depending on each hot roll press equipment. When laminating the positive electrode mixture sheets, the weight per unit area of the positive electrode mixture layer at (on) one surface of the positive electrode current collector is adjusted to be greater than or equal to about 15 mg/cm² and less than or equal to about 70 mg/cm². The weight per unit area of the positive electrode mixture layer on one surface of the positive electrode current collector may be greater than or equal to about 25 mg/cm² and less than or equal to about 70 mg/cm², or greater than or equal to about 30 mg/cm² and less than or equal to about 50 mg/cm².

### 3-2. Manufacturing Method of Negative Electrode

First, each component contained in the aforementioned base layer is suspended in a solvent such as water to prepare a base layer slurry in a slurry state, and this base layer slurry is coated and dried on the negative electrode current collector to form (or provide) a base layer. Herein, a coating amount of the base layer slurry is such that the thickness of the base layer after drying may be, for example, greater than or equal to about 0.5 μm and less than or equal to about 5 μm. The thickness of the base layer after drying may be greater than or equal to about 0.5 μm and less than or equal to about 2 μm, and for example, greater than or equal to about 0.5 m and less than or equal to about 1.5 μm. In one or more embodiments, the method of coating is not particularly limited. The coating method may include a knife coater method, a gravure coater method, a reverse roll coater, a slit die coater, and/or the like. Each of the following coating processes may also be performed by substantially the same method.

Next, a negative electrode active material, a conductive agent, and a negative electrode binder are mixed in a desired or suitable ratio and kneaded to manufacture a negative electrode mixture lump, and the negative electrode mixture lump is compressed to manufacture a negative electrode mixture sheet. A negative electrode is manufactured by a dry method in which the negative electrode mixture sheet is laminated on the base layer utilizing a hot roll press and/or the like. In one or more embodiments, the manufacturing equipment utilized in the process of laminating the negative electrode mixture sheet to the base layer by a dry method is not particularly limited. As manufacturing equipment utilized in the process of laminating the negative electrode mixture sheet to the base layer, roll press equipment, hot roll press equipment, dry laminator, calendar processing equipment, heat press equipment, and/or the like may be considered/utilized. In the above laminating process, for example, if (e.g., when) utilizing a hot roll press equipment, the press roll temperature of the hot roll press equipment can be appropriately or suitably changed depending on the material utilized in the negative electrode mixture layer and/or the like, but may be greater than or equal to about 20° C. and less than or equal to about 150° C., greater than or equal to about 40° C. and less than or equal to about 120° C., or for example greater than or equal to about 60° C. and less than or equal to about 100° C. Moreover, the rotation speed of the press roll may be greater than or equal to about 0.1 m per minute and less than or equal to about 10 m per minute, greater than or equal to about 0.1 m per minute and less than or equal to about 5 m per minute, or for example greater than or equal to about 0.1 m per minute and less than or equal to about 1.0 m per minute. Various parameters, including the temperature of the press roll and the rotation speed of the press roll, may have different desirable ranges depending on the hot roll press equipment utilized, and the parameters may be adjusted depending on the hot roll press equipment. When laminating the negative electrode mixture sheets, the weight per unit area of the negative electrode mixture layer at (on) a surface (e.g., one surface or side) of the negative electrode current collector is adjusted to be greater than or equal to about 10 mg/cm² and less than or equal to about 35 mg/cm².

Additionally, a negative electrode slurry is produced by dispersing the mixed materials constituting the negative electrode mixture layer in a solvent for a negative electrode slurry. Next, a negative electrode mixture layer may be formed by coating the negative electrode slurry on the negative electrode current collector and drying it. When forming (or providing) the negative electrode mixture layer in this way by coating and drying, the negative electrode mixture layer may be compressed utilizing a press machine to achieve the aforementioned density.

### 3-3. Manufacturing Method of Non-Aqueous Electrolyte Rechargeable Battery

Next, an electrode structure is manufactured by placing a separator between the positive electrode and the negative electrode. Then, the electrode structure may be processed into a desired or suitable shape (e.g., cylindrical shape, prismatic shape, laminated shape, button shape, and/or the like) and inserted into a container of the above shape. Subsequently, a non-aqueous electrolyte solution is inserted into the corresponding container to impregnate the electrolyte solution into each pore in the separator or a gap between the positive electrode and negative electrode. Accordingly, a rechargeable lithium ion battery is manufactured.

### 4. Effect of One or More Embodiments of the Present Disclosure

According to the non-aqueous electrolyte rechargeable battery configured as above, relatively high energy density of the non-aqueous electrolyte rechargeable battery is achieved by increasing the weight per unit area of the negative electrode mixture layer and reducing the thickness of the base layer as much as possible. Thus, falling off and/or peeling off of the electrode mixture layer from the negative electrode current collector after impregnation with the electrolyte solution may be sufficiently suppressed or reduced.

### 5. One or More Embodiments of the Present Disclosure

The present disclosure is not limited to the aforementioned embodiments.

In the aforementioned embodiments, the case where the base layer is formed only on one surface of the negative electrode current collector has been described, but the base layer and the negative electrode mixture layer may be provided on both (e.g., opposite) surfaces (e.g., sides) of the negative electrode current collector.

In the above embodiments, the base layer is provided between the negative electrode current collector and the negative electrode mixture layer. However, the base layer according to one or more embodiments of the present disclosure may be installed between the positive electrode current collector and the positive electrode mixture layer, and can prevent or reduce the positive electrode mixture layer from falling off or peeling from the positive electrode current collector after impregnation with the electrolyte solution.

The base layer according to one or more embodiments of the present disclosure is not limited to non-aqueous electrolyte rechargeable batteries that do not have a solid electrolyte layer, but can also be applied to semi-solid rechargeable batteries or all-solid rechargeable batteries that have a solid electrolyte layer.

### Examples

Hereinafter, the present disclosure will be described in more detail with respect to specific examples. However, the following examples are only to illustrate certain embodiments of the present disclosure, and the present disclosure is not limited to the following examples.

### Preparation of Base Layer Slurry

First, after preparing a carbon material dispersion in the following procedure, this carbon material dispersion was utilized to prepare Base Layer Slurries 1 to 5.

### Preparation of Dispersion 1

Herein, acetylene black was utilized as a carbon material, and non-neutralized polyacrylic acid was utilized as a dispersant. The acetylene black (greater than or equal to 65 g and less than or equal to 75 g), an aqueous solution of the polyacrylic acid (greater than or equal to about 25 g and less than or equal to about 35 g of the polyacrylic acid, as a dried product made by removing water from the aqueous solution), and 1030 g of water were mixed for 20 minutes by utilizing a disperser. The obtained mixture was subject to a high-pressure dispersion treatment utilizing NanoVator manufactured by Yoshida Manufacturing Corp. The high-pressure dispersion treatment was three times repeated to obtain Acetylene black dispersion 1. As a result of drying this dispersion at 120° C. in a drying furnace, the dispersion had a dried solid content (e.g., amount) (solid concentration) of about 8 wt %. Notably, even if the contents of the carbon material and the dispersant (polyacrylic acid) were changed within the above ranges, the result in each evaluation test was not substantially changed.

### Preparation of Dispersions 2 to 5

Dispersions 2 to 5 were prepared in substantially the same manner as above, except that the polyacrylic acid utilized as a dispersant was neutralized by utilizing a sodium hydroxide aqueous solution. The prepared dispersions had a composition shown in Table 1.

Table 1 also shows the pH of polyacrylic acid and each aqueous solution of the neutralized polyacrylic acids utilized for the dispersions.

TABLE 1

| | Dispersant | | |
|---|---|---|---|
| | neutralization | Dispersant | |
| | degree (mol %) | pH | Dispersibility |
| Dispersion 1 | 0 | 2.5 | ◯ |
| Dispersion 2 | 10 | 4.2 | ◯ |
| Dispersion 3 | 25 | 4.7 | ◯ |
| Dispersion 4 | 50 | 5.1 | ◯ |
| Dispersion 5 | 75 | 5.77 | ◯ |

### Evaluation of Neutralization Degree of Dispersant

The neutralization degree of the dispersant in Table 1 was measured as follows. 2 M sodium hydroxide solution was titrated with 100 g/L of the solution of polyacrylic acid or neutralized polyacrylic acid. The neutralization degree was set to 100% when the pH of the solution of polyacrylic acid or neutralized polyacrylic acid which titrated the sodium hydroxide solution becomes 10. The neutralization degree of the solution of the polyacrylic acid or neutralized polyacrylic acid was calculated from an amount of the solution of the polyacrylic acid or neutralized polyacrylic acid until the neutralization degree reached 100%.

### Evaluation of Dispersibility of Dispersions

Dispersions 1 to 5 were evaluated with respect to dispersibility by utilizing a grind meter (0 to 50 μm) manufactured by BYK. Whether or not aggregates were formed in the dispersions was checked with manually (e.g., with the naked eye). If no aggregates were found, ∘ was given, but if aggregates were found, x was given. The results are shown in Table 1.

Referring to Table 1, if a carboxyl group of the polyacrylic acid utilized as a dispersant of the dispersions was non-neutralized (Dispersion 1) or 75% or less of carboxyl groups thereof were neutralized (Dispersions 2 to 5), the dispersions all turned out to have excellent or suitable dispersibility. In general, carbon material with excellent or suitable conductivity, which includes the acetylene black utilized as carbon material in embodiments and examples of the present disclosure, have relatively high purity and slightly alkaline pH on the particle surface. Accordingly, a dispersant, which has pH of less than 7, is expected to be effectively absorbed onto the surface of the slightly alkaline carbon material surface.

### Preparation of Base Layer Slurry

A copolymer (also, referred to as SBR) of styrene and butadiene, an acrylic rubber, or polyvinylidene fluoride (also, referred to as PVDF) was utilized as a binder for a base layer, and after preparing the copolymer as an aqueous dispersion of resin particulates by adjusting its dried solid content (e.g., amount) (solid concentration) to be 40.0 wt %, this aqueous dispersion and the aforementioned Dispersion 1 were added to a stirring container to meet a binder amount contained in a base layer as shown in Table 2. SBR utilized in this example had a glass transition temperature (measured by DSC (X-DSC7000, Hitachi High Tech Science Corporation) and hereinafter the glass transition temperature was measured in the same manner) of 7° C., and the acrylic rubber had a glass transition temperature of 15° C. The stirring container was mounted on a rotation/revolution mixer (ARE-310 manufactured by THYNKY) to mix for 10 minutes, obtaining each base layer slurry with a composition shown in Table 2. As a result of drying and weighing these base layer slurries, the base layer slurries all had a dried solid content (e.g., amount) (solid concentration) of about 15%.

Subsequently, negative electrode mixture sheets were manufactured according to the following procedures.

### Manufacturing of Negative Electrode Mixture Sheet 1

Powders of natural graphite, artificial graphite, single-layer carbon nanotube, and polytetrafluoroethylene were weighed in a weight ratio of 48.2:48.2:0.1:3.5 and kneaded in a mortar for 10 minutes. After the kneading, a lump-shaped negative electrode mixture was passed between two rolls about 100 times to manufacture a negative electrode mixture sheet with a thickness of about 180 μm and density of 1.2 g/cm³ to 1.4 g/cm³. In the process of passing the lump-shaped negative electrode mixture between the two rolls about 100 times, a gap of the two rolls was gradually narrowed from 3 mm to finally to about 0.1 mm.

In order to adjust density of a negative electrode mixture sheet obtained in the aforementioned method to 1.6 g/cm³ and a weight per unit area of the negative electrode mixture layer to 17 mg/cm², the negative electrode mixture sheet was roll-pressed by a hot roll press. The hot roll press was set at a temperature of 75° C. and a rotation speed of 0.5 m/min. After adjusting the roll gap into 30 μm, the negative electrode mixture sheet formed with a dimension of 3.0 cm×8.0 cm was 3 to 8 times passed in a length direction. In the rolling process, a total pressure was 3 kN, and a linear pressure was 100 KN/m. The manufactured negative electrode mixture sheet was punched to 15.5φ and measured with respect to a weight and a thickness. The obtained weight and thickness were utilized to calculate negative electrode mixture density and weight per unit area of the negative electrode mixture layer, which were respectively about 1.6 g/cm³ and about 17 mg/cm².

### Manufacturing of Negative Electrode Mixture Sheet 2

In the rolling process, the weight per unit area of the negative electrode mixture layer was reduced by increasing the number of times the negative electrode mixture sheet was passed between rolls. In the rolling process, the number of times the negative electrode mixture sheet was passed between the rolls was changed from 25 to 35 to manufacture Negative Electrode Mixture Sheet 2 having a negative electrode mixture density of about 1.6 g/cm³ and a weight per unit area of the negative electrode mixture layer of about 10 mg/cm².

### Manufacturing of Negative Electrode Mixture Sheet 3

A plurality of the negative electrode mixture sheets manufactured in the rolling process was overlapped and rolled together to increase the weight per unit area of the negative electrode mixture layer. Two negative electrode mixture sheets having a negative electrode mixture density of about 1.6 g/cm³ and a weight per unit area of the negative electrode mixture layer of about 17.5 mg/cm² were overlapped in a plane direction and then rolled by changing the roll gap to 60 μm to manufacture Negative Electrode Mixture Sheet 3 having a negative electrode mixture density of about 1.6 g/cm³ and a weight per unit area of the mixture layer of about 35 mg/cm².

Using the base layer slurry and negative electrode mixture sheets manufactured as described above, negative electrodes were manufactured in the following procedure.

### Manufacturing of Negative Electrode

### Example 1

The Base Layer Slurry was coated on one side of an about 8 μm-thick copper foil (negative electrode current collector). The coating was performed by utilizing a micro gravure coater, and after the coating, drying was performed at 80° C. for 1 minute to form a 1 μm-thick base layer on the negative electrode current collector.

Subsequently, Negative Electrode Mixture Sheet 1 manufactured in the aforementioned method was adhered onto the negative electrode current collector with the base layer with a heat roll press. Heat rolls of the heat roll press were set at a temperature of 80° C. and a rotation speed of 0.5 m/min. After setting a gap between the rolls to be 45 μm, the negative electrode mixture sheet was mounted on the base layer laminated on the current collector and then passed once between the rolls to manufacture a negative electrode.

The rotation speed of the rolls utilized in each Example and Comparative Example may have had a deviation of about ±0.2 m per minute, but such a deviation, if it occurred, had substantially no effect on the properties of the manufactured negative electrode mixture sheets. In addition, the roll gaps utilized in each Example and Comparative Example could have had a deviation, if it occurred, of about ±10 μm, but again such a deviation resulted in substantially no effect on the properties of the manufactured negative electrode mixture sheets. In the adhesion process, a total pressure was 3 kN, and a linear pressure was 100 KN/m.

The negative electrode manufactured was dried at 145° C. for 6 hours in a vacuum-drier. After the vacuum-drying, the negative electrode was punched to 15.5φ and measured with respect to a weight and a film thickness. The weight and the film thickness were utilized to calculate negative electrode mixture density and a weight per unit area of the negative electrode mixture layer, which were respectively about 1.6 g/cm³ and about 17.0 mg/cm².

### Examples 2 to 5 and Comparative Examples 1 to 4

Negative electrodes for Examples 2 to 5 and Comparative Examples 1 to 4 were manufactured in substantially the same manner as in Example 1, except that the base layer slurries shown in Table 2 were utilized. The roll gap was adjusted to be a value obtained by the following calculation formula according to a weight per unit area of the utilized negative electrode mixture sheet (e.g., Negative Electrode Mixture Sheet 1).

$$Roll gap = ( Weight per unit area of the negative electrode mixture sheet utilized ) \div 17 \times 45 μ m$$

### Performance Evaluation Test of Negative Electrode

Method for Evaluating the Close Contacting Property of the Negative Electrode Mixture Layer to the Negative Electrode Current Collector after Impregnation with Electrolyte Solution

Each of the negative electrodes of Examples 1 to 5 and Comparative Examples 1 to 4 was inserted with an electrolyte solution into an aluminum laminate and then, sealed with a laminator and stored at 60° C. in a thermostat for 3 days. The electrolyte solution was prepared by dissolving 1.15 M of LiPF₆ and 1.0 wt % of vinylene carbonate in a solvent of ethylene carbonate/dimethyl carbonate/ethyl methyl carbonate mixed in a volume ratio of 20/20/40. Herein, the electrolyte solution was added sufficiently enough to fully immerse the negative electrode, when the negative electrode was stored in the thermostat. After 3 days, the aluminum laminate was taken out from the thermostat and moved into a dry room with a dew point of −30° C. The aluminum laminate was opened to take out the negative electrode plate, and the electrolyte solution was quickly wiped off therefrom. The negative electrode plate was cut into a rectangular shape with a width of 25 mm and a length of 80 mm. Subsequently, the mixture layer surface of the negative electrode was attached to a stainless steel sheet by utilizing a double-sided adhesive tape to manufacture a sample for evaluating close contacting property. The sample for evaluating close contacting property was mounted on a peeling tester (SHIMAZU EZ-S, Shimadzu Corp.), of which a peeling speed was set to 100 mm/min to measure peel strength with a length 60 mm and an angle of 180°.

Reference for Evaluating Close Contacting Property of Negative Electrode Mixture Layer with Negative Electrode Current Collector after Impregnation with Electrolyte Solution

When the peel strength was greater than or equal to 2.0 gf/mm, the close contacting property was evaluated as ⊚. When the peel strength was greater than or equal to 1.0 gf/mm and less than 2.0 gf/mm, the close contacting property was evaluated as ∘, and when less than 1.0 gf/mm, the close contacting property was evaluated as x. The results are shown in Table 2.

### Manufacturing of Positive Electrode

### Formation of Base Layer

The base layer slurry utilized in Example 1 was coated on one side of an about 12 μm-thick aluminum foil (positive electrode current collector). The coating was performed by utilizing a micro gravure coater, and after the coating, drying was performed at 80° C. for 1 minute to form a 1 μm-thick base layer on the positive electrode current collector.

### Manufacturing of Positive Electrode Mixture Sheet 1

Powders of LiNi_{0.8}Co_{0.1}Al_{0.1}O₂, acetylene black, and polytetrafluoroethylene were weighed in a weight ratio of 93.0:3.5:3.5 and kneaded in a mortar for 10 minutes. After the kneading, a lump-shaped positive electrode mixture was passed between two rolls about 100 times to manufacture a positive electrode mixture sheet with a film thickness of about 150 μm and density of 2.9 g/cm³ to 3.1 g/cm³. In the process of passing the lump-shaped positive electrode mixture between the two rolls about 100 times, a gap between the two rolls was gradually narrowed from 3 mm to finally about 0.1 mm.

In order to adjust the positive electrode mixture density of the positive electrode mixture sheet obtained in the above method and a weight per unit area of the positive electrode mixture layer, respectively, to 3.6 g/cm³ and 30.0 mg/cm², the positive electrode mixture sheet was rolled by utilizing a hot roll press. A temperature of the hot roll press was set at 40° C., and a rotation speed of the rolls was set at 0.5 m/min. After adjusting the roll gap to 10 μm, the positive electrode mixture sheet formed with a dimension of 3.0 cm×8.0 cm was twice passed between the rolls in a length direction. Subsequently, the roll gap was adjusted to 5 μm to pass the positive electrode mixture sheet before passing the positive electrode mixture sheet between the rolls two more times. In the rolling process, a total pressure was 3 kN, and a linear pressure was 100 KN/m. When the manufactured positive electrode mixture sheet was punched to 15.5φ to measure a weight and a film thickness, the film thickness was about 100 μm, positive electrode mixture density was about 3.6 g/cm³, and a weight per unit area of the positive electrode mixture layer was about 30.0 mg/cm².

### Manufacturing of Positive Electrode Mixture Sheet 2

In the rolling process, the weight per unit area of the positive electrode mixture layer was reduced by increasing the number of times the positive electrode mixture sheet was passed between the rolls. In the rolling process, the number of times the positive electrode mixture sheet was passed between the rolls was changed from 25 to 35 to manufacture Positive Electrode Mixture Sheet 2 having a positive electrode mixture density of about 3.6 g/cm³ and a weight per unit area of the positive electrode mixture layer of about 18 mg/cm².

### Manufacturing of Positive Electrode Mixture Sheet 3

A plurality of the positive electrode mixture sheets manufactured in the rolling process was overlapped and rolled together to increase the weight per unit area of the positive electrode mixture layer. Two positive electrode sheets having mixture density of about 3.6 g/cm³ and a weight per unit area of about 31 mg/cm² were overlapped in a plane direction and then rolled by changing the roll gap to 60 μm to manufacture Positive Electrode Mixture Sheet 3 having positive electrode mixture density of about 3.6 g/cm³ and a weight per unit area of the mixture layer of about 62 mg/cm².

### Adhesion of Positive Electrode Mixture Sheet 1 to Current Collector

Positive Electrode Mixture Sheet 1 prepared in the above method was adhered by utilizing a hot roll press onto a current collector on which a base layer was formed to manufacture each positive electrode of Examples 1 to 5 and Comparative Examples 1 to 4 shown in Table 2.

First, a temperature of the hot roll press was set at 60° C., and a rotation speed of the rolls was set at 0.5 m/min. After adjusting the roll gap to 60 μm, each positive electrode mixture sheet was mounted on the base layer coated to be 1 μm thick on the current collector and then passed once between the rolls.

The rotation speed of the rolls utilized in each Example and Comparative Example may have had a deviation of about +0.2 m per minute, but such a deviation, if it occurred, had substantially no effect on the properties of the manufactured positive electrode mixture sheets. In addition, the roll gaps utilized in each Example and Comparative Example could have had a deviation of about +10 μm, but again such a deviation, if it occurred, resulted in substantially no effect on the properties of the manufactured negative electrode mixture sheets. In the adhesion process, a total pressure was 3 kN, and a linear pressure was 100 KN/m.

The positive electrodes manufactured in this way were dried at 80° C. for 6 hours in a vacuum-drier. After the vacuum-drying, the positive electrodes were punched to 15.5φ and measured with respect to a weight and a film thickness. The weight and the film thickness were utilized to calculate negative electrode mixture density and a weight per unit area of the negative electrode mixture layer, which were respectively about 3.6 g/cm³ and about 30.0 mg/cm².

### Adhesion of Positive Electrode Mixture Sheets 2 and 3 to Positive Electrode Current Collector

Positive Electrode Mixture Sheets 2 and 3 were adhered in substantially the same adhesion process as Positive Electrode Mixture Sheet 1 except that the roll gap was changed. The roll gap was adjusted to be a value obtained by the following calculation formula according to a weight per unit area of the utilized positive electrode mixture sheet.

$$Roll gap = Weight per unit area of the positive electrode mixture sheet utilized \div 30 \times 60 μ m$$

### Preparation of Rechargeable Battery Cell

After respectively welding a nickel wire and an aluminum wire (lead wires) to each negative and positive electrode for each of Examples 1 to 5 and Comparative Examples 1 to 4, one sheet of the negative electrode and one sheet of the positive electrode to face each other were laminated with a porous polyethylene separator interposed therebetween to manufacture each electrode laminate. Subsequently, the electrode laminate was housed in an aluminum laminate film with the lead wires externally pulled out, an electrolyte (e.g., an electrolyte solution) was injected thereinto, and the aluminum laminate film was sealed under a reduced pressure to manufacture a rechargeable battery cell before initial charge. The electrolyte was prepared by dissolving 1.15 M LiPF₆ and 1.0 wt % of vinylene carbonate in a mixed solvent of ethylene carbonate/dimethyl carbonate/fluoroethylene carbonate in a volume ratio of 20/40/40. Rechargeable battery cells of each Example and Comparative Example, in which weights per unit area of the positive and negative electrodes was optimally or sufficiently balanced, were manufactured by respectively utilizing Negative Electrode Mixture Sheet 2 and Positive Electrode Mixture Sheet 2. In contrast, Negative Electrode Mixture Sheet 2 and Positive Electrode Mixture Sheet 2 in Examples 2-5 and Negative Electrode Mixture Sheet 3 and Positive Electrode Mixture Sheet 3 in Examples 2-6 were respectively utilized to manufacture rechargeable battery cells, which will be described in more detail later.

### Performance Evaluation of Rechargeable Battery Cells

### Aging of Rechargeable Battery Cells

The rechargeable battery cells manufactured by utilizing the negative electrodes according to Examples 1 to 5 and Comparative Examples 1 to 4 were stored at 45° C. for 12 hours before charging and discharging and continuously stored at 25° C. for 24 hours in a thermostat.

### Charge/Discharge Test of Rechargeable Battery Cells

The rechargeable battery cells manufactured by utilizing the negative electrodes according to Examples 1 to 5 and Comparative Examples 1 to 4 and then aged in the aforementioned method were connected to a charge and discharge device to perform a charge and discharge test at 25° C. in a thermostat. The initial charge and discharge were performed through a constant current charge at 0.1 CA, a constant voltage charge to 0.05 CA and then, a constant current discharge at 0.1 CA with a charge cut-off voltage of 4.25 V and a discharge cut-off voltage of 2.8 V. The 2^{nd} and 3^{rd} charge and discharge were respectively performed through a constant current charge at 0.2 CA and a constant voltage charge to 0.05 CA, and then a constant current discharge at 0.2 CA with a charge cut-off voltage of 4.25 V and a discharge cut-off voltage of 2.8 V.

### Rate Capability Evaluation Method

Full-discharge capacity of the rechargeable battery cells in the above charge and discharge test, which were constant current-charged at 0.33 CA and constant voltage-charged to 0.05 CA, and then constant current-discharged at 0.33 CA with a charge cut-off voltage of 4.25 V and a discharge cut-off voltage of 2.8 V, was set to a state-of-charge (SOC) of 100%

A discharge voltage at SOC 10%, when the cells were constant current-charged at 0.33 CA and constant voltage charged to 0.05 CA, and then constant current-discharged at 2 CA with a charge cut-off voltage of 4.25 V and a discharge cut-off voltage of 2.8 V, was measured to evaluate rate capability. If (e.g., when) the discharge voltage was greater than or equal to 3.8 V at SOC 10%, ⊚ was given, if (e.g., when) the discharge voltage was greater than or equal to 3.5 V and less than 3.8 V, ∘ was given, and if (e.g., when) the discharge voltage was less than 3.5 V, x was given. The results are shown in Table 2.

TABLE 2

| | | Binder | | | |
|---|---|---|---|---|---|
| | | content | | Close | |
| | | (e.g., | | contacting | |
| | | amount) | | property | |
| | | in base | Neutrali- | after | |
| | | layer | zation | impregnation | |
| | Binder | (dried | degree | with | 2 CA |
| | for | solids, | of | electrolyte | discharge |
| | base | parts by | dispersant | solution | voltage |
| | layer | weight) | (mol %) | (gf/mm) | (V) |
| Example 1 | SBR1 | 50 | 0 | ⊚ | ⊚ |
| Example 2 | SBR1 | 60 | 0 | ⊚ | ⊚ |
| Example 3 | SBR1 | 70 | 0 | ⊚ | ⊚ |
| Example 4 | SBR1 | 80 | 0 | ⊚ | ⊚ |
| Example 5 | SBR1 | 90 | 0 | ⊚ | ◯ |
| Comparative | acrylic | 60 | 0 | X | ⊚ |
| Example 1 | rubber | | | | |
| Comparative | acrylic | 70 | 0 | X | ⊚ |
| Example 2 | rubber | | | | |
| Comparative | SBR1 | 40 | 0 | X | ⊚ |
| Example 3 | | | | | |
| Comparative | PVDF | 60 | 0 | X | ⊚ |
| Example 4 | | | | | |

### Discussion of Evaluation Results

Referring to the results of Table 2, Examples 1 to 5 having the base layer according to embodiments of the present disclosure, even if the negative electrode mixture layer had a sufficiently large weight per unit area of 17 mg/cm², and the base layer had a sufficiently small thickness of 1 μm, compared to Comparative Examples 1 and 2 utilizing an acrylic rubber as a binder for a base layer, each provided a negative electrode with significantly improved close contacting property after impregnation with an electrolyte solution. The reason for this result is that the base layer included a styrene-butadiene copolymer as a binder and thus suppressed or reduced penetration of an electrolyte solution into the base layer and resultantly, reduced a swelling rate, compared to the case of including acrylic rubber as a binder.

In addition, Examples 1 to 5, compared to Comparative Example 4 utilizing PVDF as a binder, turned out to significantly improve close contacting property after impregnation with an electrolyte solution.

This action mechanism may be said to have achieved the same effect with respect to the positive electrode as the base layer of Examples 1 to 5 was utilized in the positive electrode as well.

In addition, although not listed in Table 2, the negative electrodes of Examples 1 to 5 exhibited a sufficiently practical value of 3 gf/mm or more for a close-contacting force before impregnation with an electrolyte solution.

Referring to the results of Examples 1 to 5 and Comparative Example 3, when a dried binder included in a base layer was 50 wt % or more, a close contacting property after impregnation with an electrolyte solution was sufficiently large. In general, peeling and falling off of the negative electrode mixture layer from the negative electrode current collector after impregnation with an electrolyte solution may cause deterioration of electric capacity of rechargeable battery cells, deterioration of rate performance, and deterioration of cycle-life characteristics. In this respect, the base layer utilized in Examples 1 to 5, as described above, exhibited a sufficiently large close contacting property after impregnation with an electrolyte solution and thus, was advantageous in terms of improving electrical capacity, rate performance, and cycle-life characteristics of rechargeable battery cells.

In addition, referring to the results of Examples 1 to 5, if a base layer had a dried binder content (e.g., amount) of 90 parts by weight or less, excellent or suitable rate capability was achieved. The reason is that the binder content (e.g., amount) included in the base layer was set at 90 wt % or less to prevent or substantially prevent a carbon material from being included in an excessively (or substantially) low amount in the base layer and suppress or reduce electrical resistance of the base layer to a relatively low level. Further, if (e.g., when) a discharge voltage is relatively high during a relatively high-rate discharge, energy density of rechargeable battery cells in the relatively high-rate discharge is improved. In this regard, the base layer of Examples 1 to 5, as described above, exhibited sufficiently excellent or suitable rate capability and thus was advantageous in terms of improving energy density in the relatively high-rate discharge.

In addition, after coating a base layer with the same composition as in Example 2 to have a thickness of greater than or equal to about 0.5 μm and less than or equal to about 5 μm, the results evaluated in substantially the same procedure as in Example 1 are shown in Table 3. Referring to the results of Table 3, the film thickness was greater than or equal to about 0.5 μm and less than or equal to about 5 μm, which was sufficiently small, and also, a sufficiently large close contacting property after impregnation with an electrolyte solution was obtained. In addition, the film, even if the film thickness was 5 μm, had no influence on rate capability of the cells.

TABLE 3

| | | | | Close | |
|---|---|---|---|---|---|
| | | | | contacting | |
| | | | | property after | |
| | | Neutrali- | Thick- | impregnation | |
| | Binder | zation | ness | with | 2 CA |
| | for | degree of | of base | electrolyte | discharge |
| | base | dispersant | layer | solution | voltage |
| | layer | (mol %) | (μm) | (gf/mm) | (V) |
| Example 2 | SBR1 | 0 | 1 | ⊚ | ⊚ |
| Example 2-2 | SBR1 | 0 | 0.5 | ⊚ | ⊚ |
| Example 2-3 | SBR1 | 0 | 2 | ⊚ | ⊚ |
| Example 2-4 | SBR1 | 0 | 5 | ⊚ | ⊚ |

Table 4 shows the evaluation results by utilizing a base layer with the same composition as in Example 2 but changing a weight per unit area of a negative electrode mixture layer. Referring to Table 4, even though a negative electrode mixture layer had a weight per unit area of greater than or equal to 10 mg/cm² and less than or equal to 35 mg/cm², a sufficient close contacting property after impregnation with an electrolyte solution was obtained.

TABLE 4

| | Negative | Close contacting | |
|---|---|---|---|
| | electrode | property after | |
| | mixture layer | impregnation | 2 CA |
| | weight per | with electrolyte | discharge |
| | unit area | solution | voltage |
| | (mg/cm²) | (gf/mm) | (V) |
| Example 2 | 17 | ⊚ | ⊚ |
| Example 2-5 | 10 | ⊚ | ⊚ |
| Example 2-6 | 35 | ⊚ | ⊚ |

In Examples 1 to 5, which utilized a dispersant with a neutralization degree of 50% or less, the dispersant was sufficiently adsorbed in a carbon material to create a sufficiently large repulsive force among particles of the carbon material, so that the carbon material might be sufficiently dispersed in the base layer slurry. Referring to Table 5, even though the neutralization degree of the dispersant was changed into 10%, 25%, and 50%, a sufficiently close contacting property after impregnation with an electrolyte solution was obtained.

TABLE 5

| | | Close contacting | |
|---|---|---|---|
| | Neutralization | property | 2 CA |
| | degree | after impregnation | discharge |
| | of dispersant | with electrolyte | voltage |
| | (mol %) | solution (gf/mm) | (V) |
| Example 2 | 0 | ⊚ | ⊚ |
| Example 2-7 | 10 | ⊚ | ⊚ |
| Example 2-8 | 25 | ⊚ | ⊚ |
| Example 2-9 | 50 | ⊚ | ⊚ |

As for a styrene-butadiene copolymer utilized as a binder for a base layer, one or more suitable types (kinds) of commercially available products may be utilized, but the pH of aqueous dispersions of these styrene-butadiene copolymers was found to at least be effective in a range. Regarding Table 6, slurry for a base layer was prepared in substantially the same manner as in Example 2, except that types (kinds) of the aqueous dispersions of the styrene-butadiene copolymers utilized as a binder for a base layer were changed to one of SBR 2 to 4. The evaluation results of the dispersions are shown in Table 6. Dispersibility was evaluated utilizing a grind meter (0 to 50 μm) manufactured by BYK. The presence or absence of aggregates in the dispersion was checked manually (with the naked eye), wherein, if there were no aggregates, ◯ was given, but if there were aggregates, x was given.

Referring to Table 6, an aqueous dispersion of styrene-butadiene copolymers with pH of 8 or less provided slurry for a base layer with excellent or suitable dispersibility. The slurry for a base layer with excellent or suitable dispersibility, from which smaller or less aggregates were formed, may be advantageous in terms of forming (or providing) a base layer that is thin. The thinning of the base layer is advantageous in terms of improving energy density of rechargeable batteries.

TABLE 6

| Binder for a base layer | pH | Dispersibility |
|---|---|---|
| SBR1 | 7.8 | ◯ |
| SBR2 | 5.8 | ◯ |
| SBR3 | 7.5 | ◯ |
| SBR4 | 7.9 | ◯ |

As for a swelling degree of a styrene-butadiene copolymer utilized as a binder for a base layer, it was found that there was a at least a range that was effective for an electrolyte solution. A slurry for a base layer was prepared in substantially the same manner as in Example 2, except that an aqueous dispersion of a styrene-butadiene copolymer with a relatively high swelling degree was utilized as a binder for a base layer, to evaluate performance.

The results are shown in Table 7. Referring to Table 7, when an aqueous dispersion of the styrene-butadiene copolymer had a small swelling degree of 136 wt %, a satisfactory close contacting property after impregnation with an electrolyte solution was obtained. In contrast, when an aqueous dispersion of the styrene-butadiene copolymer had a large swelling degree of 278 wt %, a close contacting property after impregnation with an electrolyte solution was slightly deteriorated, though was still within an allowable range. Referring to the result, a binder for a base layer with a small swelling degree may be utilized to suppress or reduce the binder from penetrating into a base layer and keep the base layer at a small swelling degree and thus maintain a relatively high close contacting property. A swelling degree in the Table 7 was examined as follows.

### Method of Evaluating Swelling Degree of Binder for Base Layer

Regarding Table 7, an aqueous dispersion of a binder for a base layer was poured into a petri dish made of fluororesin (e.g., perfluoroalkoxy alkanes (PFA)) and dried to form a binder film for a base layer. The drying was performed at room temperature for 2 days and at 80° C. for 6 hours, and then continuously in a vacuum-drying furnace at 80° C. for 6 hours. The obtained film had a thickness of about 1 mm.

The film was cut into a size of 5 mm×5 mm, and then inserted with an electrolyte solution into an aluminum laminate, sealed with a laminator, and stored in a thermostat at 60° C. for 3 days. The electrolyte solution was prepared by dissolving 1.15 M of LiPF₆ in a mixed solvent of ethylene carbonate/dimethyl carbonate/ethyl methyl carbonate in a volume ratio of 20/20/40. The electrolyte solution, when the film was stored in the thermostat, was utilized in a sufficient enough amount to fully immerse the film in the electrolyte solution. After 3 days, the aluminum laminate was taken out from the thermostat, the film was taken from the aluminum laminate, and the electrolyte solution was sufficiently and quickly wiped therefrom to measure a weight of the film.

A swelling degree of the binder for a base layer was calculated according to the following equation.

$$Swelling degree ( wt \% ) = weight of film after impregnation with electrolyte solution \div weight of a film before impregnation with an electrolyte solution \times 100$$

TABLE 7

| | | | Adhesion after | |
|---|---|---|---|---|
| | | | impregnation | 2 CA |
| | Binder | Swelling | with electrolyte | discharge |
| | for a | degree | solution | voltage |
| | base layer | (wt %) | (gf/mm) | (V) |
| Example 2 | SBR1 | 136 | ⊚ | ⊚ |
| Example 2-10 | SBR2 | 278 | ◯ | ⊚ |

As used herein, the term “substantially,” “about,” “approximately,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The portable device, vehicle, and/or the battery, e.g., a battery controller, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

What is claimed is:

1. An electrode comprising:
a current collector;
an electrode mixture layer; and
a conductive base layer between the current collector and the electrode mixture layer,
wherein the base layer comprises a styrene-butadiene copolymer, a carbon material, and poly(meth)acrylic acid,
an amount of the styrene-butadiene copolymer in the base layer is greater than or equal to about 50 wt % and less than or equal to about 90 wt % based on 100 wt % of the base layer,
in the poly(meth)acrylic acid, carboxyl groups included in the poly(meth)acrylic acid are not neutralized, or a proportion of neutralized carboxyl groups among the carboxyl groups is less than or equal to about 75%, and
a weight per unit area of the electrode mixture layer at one surface of the current collector is greater than or equal to about 10 mg/cm² and less than or equal to about 35 mg/cm², and
wherein the electrode is for a non-aqueous electrolyte rechargeable battery.

2. The electrode as claimed in claim 1, wherein the base layer has a thickness of greater than or equal to about 0.5 micrometer (μm) and less than or equal to about 5 μm.

3. The electrode as claimed in claim 1, wherein the base layer has a thickness of greater than or equal to about 0.5 micrometer (μm) and less than or equal to about 2 μm.

4. The electrode as claimed in claim 1, wherein the styrene-butadiene copolymer has a glass transition temperature of greater than or equal to about −30° C. and less than or equal to about 30° C.

5. The electrode as claimed in claim 1, wherein the electrode mixture layer comprises polytetrafluoroethylene in an amount greater than or equal to about 0.5 wt % and less than or equal to about 10 wt % based on 100 wt % of the electrode mixture layer.

6. The electrode as claimed in claim 1, wherein, in the poly(meth)acrylic acid, the carboxyl groups are not neutralized, or the proportion of the neutralized carboxyl groups is less than or equal to about 50%.

7. The electrode as claimed in claim 1, wherein the carbon material comprises at least one of furnace black, channel black, thermal black, ketjen black, or acetylene black.

8. A non-aqueous electrolyte rechargeable battery comprising:
a positive electrode,
a negative electrode,
a separator between the positive electrode and the negative electrode, and
an electrolyte,
wherein at least one of the positive electrode or the negative electrode is the electrode as claimed in claim 1.

9. A non-aqueous electrolyte rechargeable battery comprising:
a positive electrode,
a negative electrode,
a separator between the positive electrode and the negative electrode, and
an electrolyte solution,
wherein the negative electrode is the electrode as claimed in claim 1.
